(19) United States
(12) Patent Application Publication
(10) Pub. No.: US 2009/0027460 A1
(43) Pub. Date: Jan. 29, 2009

(54) SYSTEM FOR ALIGNING A CHARGE TUNNEL OF AN INK JET PRINTER

(76) Inventors: Paul Klinker, Louisville, KY (US); George Murad, Bartlett, IL (US)

Correspondence Address: MCANDREWS HELD & MALLOY, LTD, 500 WEST MADISON STREET, SUITE 3400, CHICAGO, IL, 60661, US

(21) Appl. No.: 11/781,611

(22) Filed: Jul. 23, 2007

(51) Int. Cl. B41J 2/085

(52) U.S. Cl. 347/76

(57) ABSTRACT

A system and method for aligning a charge tunnel of an inkjet printer. The system may include a charge tunnel unit and a charge tunnel base. The charge tunnel unit includes a slot, and is configured to impart an electrical charge on ink droplets passing through the slot. The charge tunnel unit may be at least partially pivoted about the base through the tightening or loosening of an adjustment screw. The system may also include a charge tunnel cradle that is operably connected to the charge tunnel base and the printhead deck. The charge tunnel base and the charge tunnel cradle may be operably connected to a adjustment fastener. The tightening or loosening of the adjustment fastener may linearly move the charge tunnel base, and attached charge tunnel unit, towards or away from the charge tunnel cradle, thereby allowing for the adjustment of the linear position of the slot.

### BACKGROUND OF THE INVENTION

Embodiments of the present invention generally relate to a continuous ink jet printer in which a stream of ink is broken into individual droplets which are then charged and deflected as required in order to form indicia on a substrate. In particular, embodiments of the present invention relate to a system for aligning a charge tunnel with other components of an ink jet printer.

A continuous inkjet printhead typically incorporates a drop generator having a nozzle that breaks an ink stream into uniformly spaced droplets. The ink drops can typically vary in diameter from 0.003-0.009 inch. The ink drops formed by a nozzle are charged in a charge tunnel which allows them to be deflected in a high voltage field to desired spots on a substrate. For optimum charging of drops, the charge tunnel gap is as narrow as practical considerations allow. In order for the printhead to run clean, it is desirable to align the ink stream well centered in the charge tunnel and into the catcher to gather the non-deflected drops.

Typically, the components of a printhead, including the drop generator, the charge tunnel, and the catcher, need to be aligned properly during servicing and normal use, in order to ensure that the printing system operates properly. In order to properly align these components, many printing systems include additional alignment components used in conjunction with a printhead to properly align the ink stream. These components add size and expense to the printhead.

### BRIEF SUMMARY OF THE INVENTION

Certain embodiments of the present invention provide a charge tunnel alignment system including a charge tunnel unit and a charge tunnel base. Other embodiments provide a charge tunnel alignment system including a charge tunnel unit, a charge tunnel base, and a charge tunnel cradle. In the illustrated embodiment, the charge tunnel unit includes a main body and an extension, the main body having a slot, a first sidewall, a second sidewall, a proximal end, a distal end, a top surface, and a bottom surface. The slot may extend across the main body from the first sidewall to the second sidewall. Further, the slot may extend from the upper surface down to approximately, or through, the bottom surface. The extension may be centered approximately beneath the slot. and may have a generally cylindrical configuration.

The charge tunnel base includes a main body, the main body having a top portion, a middle portion, a bottom portion, a first end, a second end, and a cavity. The first end of the charge tunnel base may include a first protrusion and a second protrusion. The cavity of the charge tunnel base may have a generally cylindrical configuration.

The charge tunnel cradle may include upper and lower arms. At least a portion of the lower arm may be configured to abut against the bottom portion of the charge tunnel base. The charge tunnel cradle may include through-holes configured to allow the passing of fasteners for operably connecting the charge tunnel cradle to the charge tunnel base, printhead deck, and/or other components of the printhead, such as the drop generator and nozzle.

In accordance with the illustrated embodiment, the extension of the charge tunnel unit may be rotatably inserted into the cavity of the charge tunnel base. Accordingly, at least a portion of the bottom surface of the charge tunnel unit may abut against, or be adjacent to, the middle portion of the charge tunnel base. Further, the proximal end of the charge tunnel unit may occupy at least a portion of the space between the first and second protrusions. The charge tunnel unit may be secured to the charge tunnel base by tightening the retainable engagement between a locking fastener, which passes through a slit in the charge tunnel unit, and a hole in the charge tunnel base.

The charge tunnel unit may be at least partially pivoted about the charge tunnel base. Such pivoting may allow for adjusting of the alignment of the slot of the charge tunnel unit with the drop generator and a catcher. According to one embodiment, an adjusting screw extending through the first protrusion, and a spring extending from the second protrusion, abut against opposite sidewalls at the proximal end of the charge tunnel unit. The spring may constantly exert a force against the charge tunnel unit, and vice versa. Accordingly, the tightening or loosening of the adjusting screw in the first protrusion may result in the spring pushing the proximal end of the charge tunnel unit towards or away from the first protrusion. In particular, the pushing force exerted on the proximal end may cause the extension to rotate within the cavity, thereby causing the main body of the charge tunnel unit to pivot about the charge tunnel base.

Once the charge tunnel unit, and associated slot, has been pivoted to the desired orientation, the position of the charge tunnel unit relative to the charge tunnel base may be secured by the tightening of the locking fastener in the mating hole in the charge tunnel base, thereby forcibly pressing at least a portion of the charge tunnel unit against the locking fastener and the charge tunnel base.

Embodiments of the present invention also provide for adjusting the linear position of the charge tunnel base, along with the attached charge tunnel unit, relative to the position of the charge tunnel cradle and the printhead deck. According to such an embodiment, the charge tunnel base may include an aperture and a recess. The aperture may be configured to securably retain an adjustment fastener that passes through a through-hole in the upper arm of the cradle. The recess is configured to receive the insertion of at least a portion of a spring. When the charge tunnel base is operably positioned in the cradle, the spring constantly exerts a force against the charge tunnel base and the charge tunnel cradle, and vice versa. As the adjustment fastener is tightened so as to linearly move the charge tunnel base closer to the upper arm of the cradle, the spring is compressed. As the adjustment fastener is loosened, the spring is extended, and pushes the charge tunnel base away from the upper arm of the cradle in a linear direction. Further, the charge tunnel base and cradle may include a mating groove and guide, respectively, that assists in directing the linear movement of the base.

When the charge tunnel base, and/or the slot in the attached charge tunnel unit, is at the desired linear position, a fastener passing through first tab in the cradle, and securably retained by or to the charge tunnel base, may be tightened, thereby locking the charge tunnel base at the desired linear position.

### BRIEF DESCRIPTION OF SEVERAL VIEWS OF THE DRAWINGS

FIG. 1 illustrates a schematic representation of a continuous ink jet printer.

FIG. 2 illustrates a perspective view of a charge tunnel alignment system and printhead components operably attached to the printhead deck of a continuous ink jet printer, according to an embodiment of the present invention.

FIG. 3 illustrates a top perspective view of a charge tunnel unit, according to an embodiment of the present invention.

FIG. 4 illustrates a bottom perspective view of a charge tunnel unit, according to an embodiment of the present invention.

FIG. 5 illustrates a isometric exploded view of a charge tunnel base and spring according to an embodiment of the present invention.

FIG. 6 illustrates a bottom perspective view of a charge tunnel base, according to an embodiment of the present invention.

FIG. 7 illustrates a perspective view of a charge tunnel cradle, according to an embodiment of the present invention.

FIG. 8 illustrates a perspective view of a charge tunnel alignment system, according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

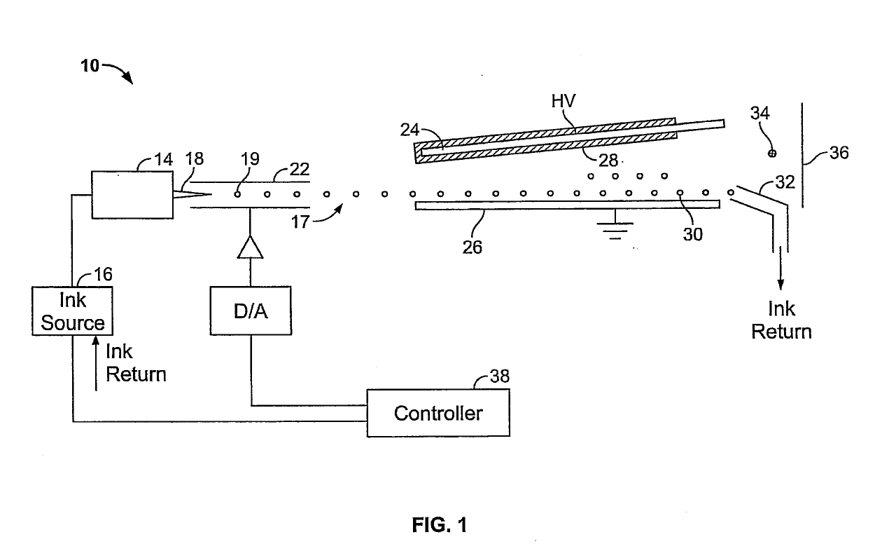

FIG. 1 illustrates a schematic representation of a continuous ink jet printer 10. The ink jet printer 10 includes a printhead with a drop generator 14 connected to receive ink from an ink source 16. The drop generator 14 incorporates a piezoelectric oscillator that creates perturbations in ink flow at a nozzle 18. The nozzle 18 emits a stream 17 of uniformly sized and spaced drops 19. The drops pass through a charging tunnel 22, where a different charge can be applied to each drop 19. The drops subsequently pass between a pair of opposed deflection electrodes 24 and 26. A power source (not shown) is operatively connected to the deflection electrodes 24 and 26 such that a relatively uniform electric field extends between the electrodes 24 and 26. The charge on a given drop determines the amount it deflects vertically as it passes between the electrodes 24 and 26. Insulation 28 may be disposed on at least one of the electrodes 24 and 26 to prevent arcing between the deflection electrodes 24 and 26, and also between the deflection electrodes 24, 26 and the charging tunnel 22.

Uncharged or slightly charged drops 30 pass substantially undeflected to a catcher 32, and are recycled to ink source 16. Charged drops 34 are projected toward a substrate 36 and are deflected so as to have a trajectory striking the substrate 36 as the substrate 36 moves past the printhead. The level of charge applied to the drop controls its vertical displacement/position on the substrate 36.

The charge to be applied to a drop is determined by a controller 38, which may be implemented by a device such as a general purpose processor, microcontroller, or embedded controller having appropriate input and output circuitry, as is well known in the art. The controller 38 operates under general program control of the instructions stored in an associated memory. The controller is programmed to deliver control signals to the charge tunnel 22 to control the charges applied to the individual drops 19 as they pass therethrough. The operation of such ink jet printers is well known in the art and, hence, will not be explained in greater detail.

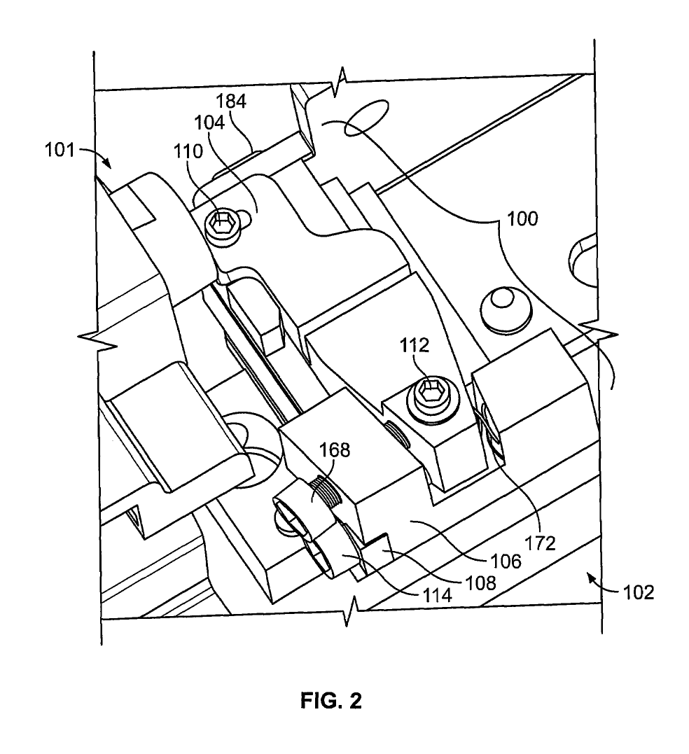

FIG. 2 illustrates a perspective view of a charge tunnel alignment system 100 and printhead components 101 operably attached to the printhead deck 102 of a continuous ink jet printer, according to an embodiment of the present invention. The system 100 includes a charge tunnel unit 104 and a charge tunnel base 106. The charge tunnel unit 104 and charge tunnel base 106 may be operably connected to each other through the use of a locking fastener 110. The charge tunnel base 106 may be operably connected to the printhead deck 102, such as through the use of a threaded fastener. Alternatively, the charge tunnel base 106 may be adjustably attached to a charge tunnel cradle 108 that is operably secured to the printhead deck 102, as discussed below in more detail.

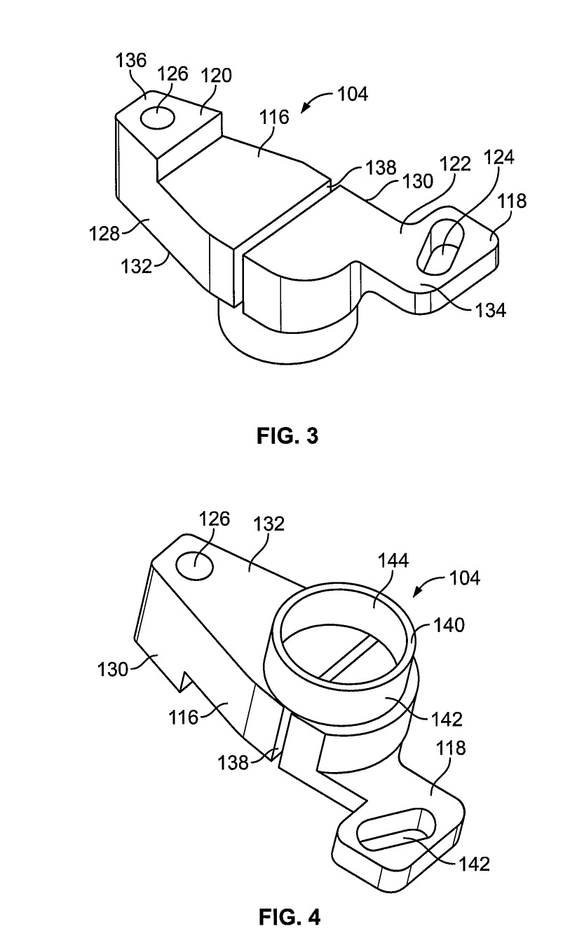

FIG. 3 illustrates a top perspective view of a charge tunnel unit 104, according to an embodiment of the present invention. The charge tunnel unit 104 includes a main body 116 having an top surface 122, a first sidewall 128, a second sidewall 130, a bottom surface 132, a distal end 134, and a proximal end 136. The distal end 134 of the main body 116 may include an integrally formed locking portion 118. Additionally, the main body 116 may be constructed of a material that is capable of holding or transmitting an electrical charge, including, but not limited to, stainless steel, to ink droplets passing through the charge tunnel unit 104.

The charge tunnel unit 104 also includes a slot 138 that is formed through a portion of the main body 116. More particularly, the slot 138 extends linearly through at least a portion of the main body 116, from the first sidewall 128 to the second sidewall 130. The slot 138, and particularly the width of the slot 138, is configured to allow for both the passage and electrical charging of ink droplets. For instance, in one embodiment of the present invention, the slot 138 may be approximately 0.020 to 0.040 inches wide. The slot 138 may also extend from the top surface 122 of the main body 116 down to approximately, or through, the bottom surface 132.

As shown in FIGS. 2 and 3, the locking portion 118 may have a slit 124 that is configured to allow for the passage of at least a portion of a locking fastener 110 through the locking portion 118. In one embodiment, the slit 124 may be a generally arc-shaped opening.

At least a portion of the proximal end 136 may include a tab 120 that extends beyond the top surface 122 of the main body 116. The tab 120 may include an aperture 126 that is configured to allow for the securable insertion of at least a portion of a charge connector 112, as shown in FIG. 2. The charge connector 112 may be used for securing an electrical wire or cable to the charge tunnel unit 104. The electrical wire may be used to deliver electrical charges to the charge tunnel unit 104, which are used to charge ink droplets passing through the slot 138. In one embodiment, the aperture 126 may include internal threads that mate the threads on the charge connector 112. However, both the slit 124 and aperture 126 may be configured to receive and/or retain various types of fasteners and connectors, such as bolts, clips, and pins, among others.

FIG. 4 illustrates a bottom perspective view of a charge tunnel unit 104, according to an embodiment of the present invention. As illustrated, the extension 140 may have a generally cylindrical configuration that may extend from the bottom surface 132 of the main body 116. The extension 140 may include an outer wall 142 and an inner wall 144. The extension 140 may be positioned so that the extension 140 is generally centered beneath the slot 138. By generally aligning the center of the extension 140 with the slot 138, the pivot point of the main body 116 in may be located at the center of the slot 138. Further, both portions of the main body 116 on either side of the slot 138 may be at least partially held together by the extension 140. However, the extension 140 may have other configurations, such as tabs, among others, that may allow the rotational movement of the extension 140 in the cavity 160 of the charge tunnel base 106, as discussed below.

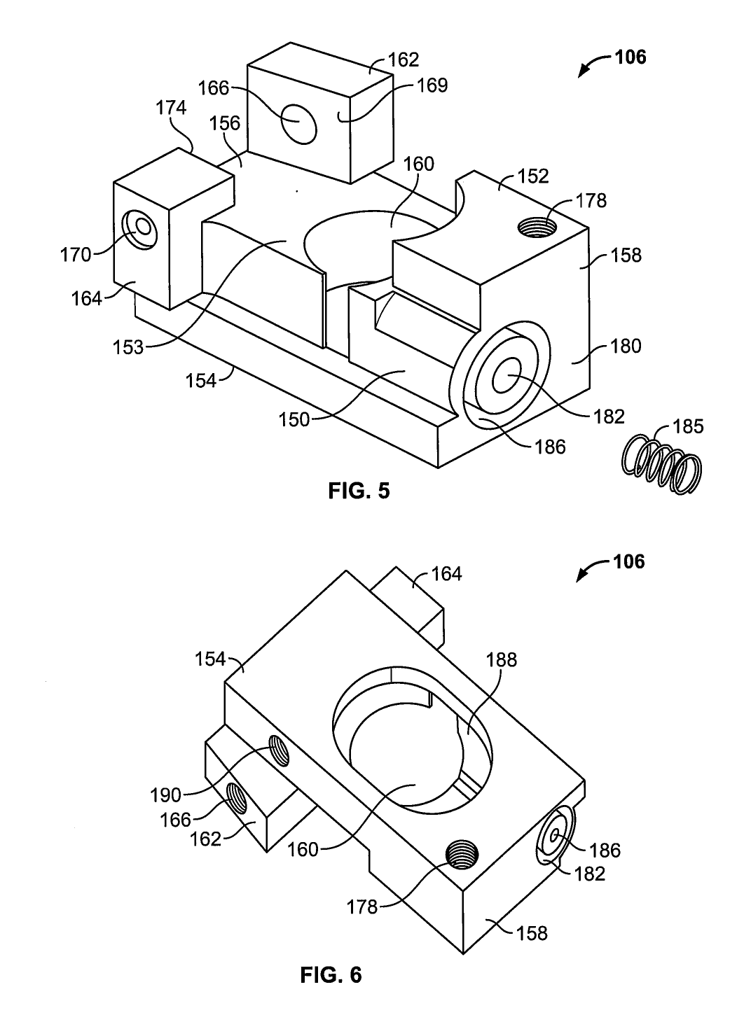

FIG. 5 illustrates a isometric exploded view of a charge tunnel base 106 and spring 185, according to an embodiment of the present invention. In one embodiment, the charge tunnel base 106 includes a main body 150, the main body 150 having a top portion 152, a middle portion 153, a bottom portion 154, a first end 156, a second end 158, and a cavity 160. The middle portion 153 of the charge tunnel base 106 may be configured to abut against, or be adjacent to, at least a portion of the bottom surface 132 of the charge tunnel unit 104. The cavity 160 of the charge tunnel base 106 may be configured to receive the rotatable insertion of the extension 140. For example, the cavity 140 may be generally cylindrically shape that is configured to receive the rotatable insertion of a generally cylindrically-shaped extension 140. Additionally, the charge tunnel base 106 may be constructed from a variety of different materials. For example, in one embodiment, the charge tunnel base 106 may be a piece of molded or extruded plastic, such as a thermoplastic, among others.

The first end 156 of the charge tunnel base 106 may include a first protrusion 162 and a second protrusion 164. The first and second protrusions 162, 164 may be spaced apart so that, when the charge tunnel unit 104 is operably placed in, or against, the charge tunnel base 106, the position of the proximal end 136 may be adjusted between the first and second protrusions 162, 164. Additionally, The first protrusion 162 may include an aperture 166. As shown by FIGS. 2 and 5, an adjusting screw 168 may be securably retained in the aperture 166, such as being threadably retained. The second protrusion 164 may include a chamber 170. At least a portion of the chamber 170 may be configured to receive the insertion of a spring 172, as shown in FIG. 2.

In one embodiment, the second end 158 of the charge tunnel base 106 may be configured to abut against at least a portion of the bottom surface 132 of the proximal end 136 of the charge tunnel unit 104. The second end 158 may also include a hole 178 that is configured to securably retain the locking fastener 110 (e.g., threadably retain), and thereby secure the charge tunnel unit 104 to the charge tunnel base 106.

The end wall 180 at the second end 158 of the charge tunnel base 106 may also include an aperture 182 that is configured to securably retain an adjustment fastener 184, shown in FIG. 2. The end wall 180 may also include a recess 186 that is configured to receive the insertion of at least a portion of a spring 185. When at least partially uncoiled, the spring 185 may extend out of the recess 186.

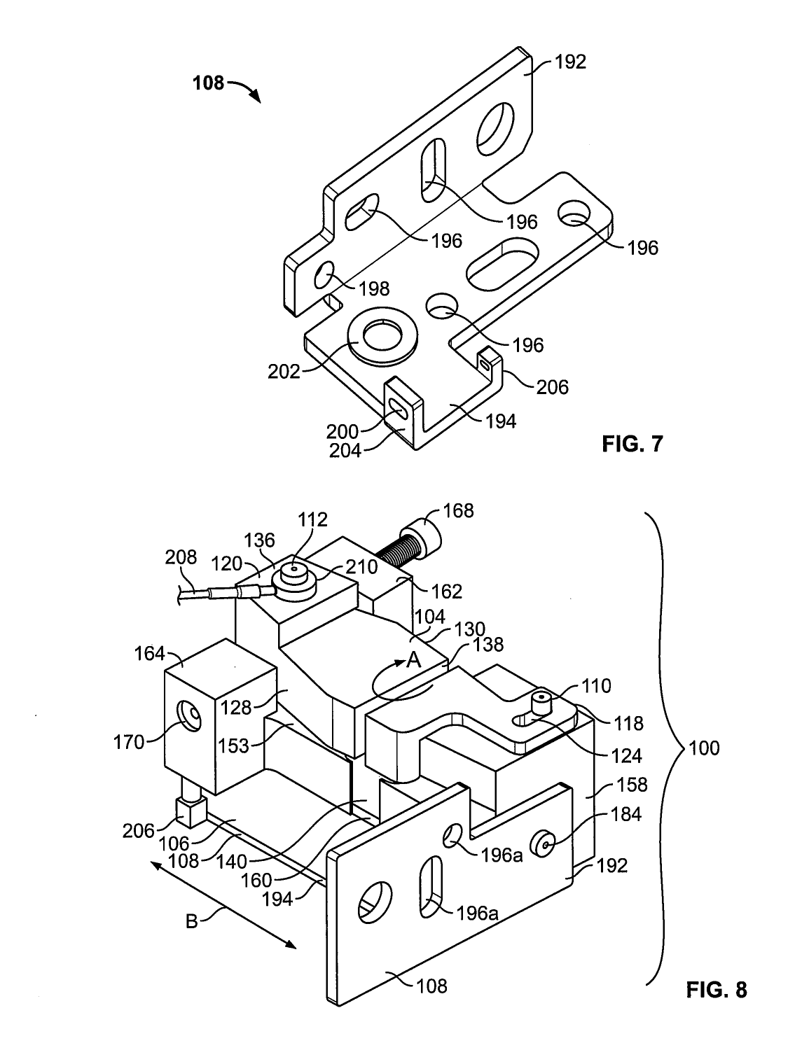

FIG. 6 illustrates a bottom perspective view of a charge tunnel base 106, according to an embodiment of the present invention. The bottom portion 154 of the charge tunnel base 106 may include a groove 188. The groove 188 may be positioned at different locations along the bottom portion 154 of the charge tunnel base 106, such as beneath the cavity 160, as illustrated in FIG. 6. Further, the groove 188 may engage a guide 202 that is part of, or operably connected to, the charge tunnel cradle 108, as shown in FIGS. 6 and 7. The engagement between the guide 202 and the groove 188 may assist in directing the linear movement of the charge tunnel base 106, as discussed below in more detail.

The charge tunnel base 106 may also include an orifice 190 for securing the charge tunnel base 106 to the charge tunnel cradle 108. More particularly, the orifice 190 may be configured to securably retain a base fastener 114 that passes through a through-hole 200 in the charge tunnel cradle 108, as shown in FIGS. 2 and 8.

FIG. 7 illustrates a perspective view of a charge tunnel cradle 108, according to an embodiment of the present invention. The charge tunnel cradle 108 may be constructed from a variety of materials, including, but not limited to, stainless steel. According to one embodiment, the charge tunnel cradle 108 includes an upper arm 192 and a lower arm 194. The upper arm 192 may be generally perpendicular to the lower arm 194. Further, the upper and lower arms 192, 194 may include through-holes 196. In the illustrated embodiment, fasteners passing through the through-holes 196 may secure printhead components 101, such as the drop generator 14 and nozzle 18, to the charge tunnel cradle 108 and/or the charge tunnel cradle 108 to the printhead deck 102. Other fasteners may pass through through-holes 196 to secure the charge tunnel cradle 108 to the charge tunnel base 106.

The charge tunnel cradle 108 may also include a first tab 204 and a second tab 206. The first tab 204 and the second tab 206 may be spaced apart so as to allow at least a portion of the first end 156 of the charge tunnel base 106 to fit there-between. Further, the first tab 204 may include a through-hole 198 that is configured to allow the passage of the adjustment fastener 184 into the charge unit base 106.

The charge tunnel cradle 108 may also include, or be operably connected to, a guide 202. For instance, in one embodiment of the present invention, the guide 202 may be a generally annular-shaped plastic insert that fits within an orifice in the cradle 108. In another embodiment, the guide 202 may be integrally formed in the cradle 108, such as a track, protrusion, or orifice.

FIG. 8 illustrates a perspective view of a charge tunnel alignment system 100, according to an embodiment of the present invention. As shown, the proximal end 136 of the charge tunnel unit 104 may be placed in at least a portion of the space between the first and second protrusions 162, 164 of the charge tunnel base 106. Further, at least a portion of the proximal end 136 may rest against at least a portion of the middle portion 153 of the charge tunnel base 106. The extension 140 of the charge tunnel unit 104 may be inserted into the cavity 160 of the charge tunnel base 106.

As previously discussed, the proximal end 136 of the charge tunnel unit 104 may include an aperture 126 that engages the charge connector 112. In the illustrated embodiment, the charge connector 112 may be a bolt or screw having a head portion 208 and a threaded portion (not shown), the threaded portion mating the internal thread of the aperture 126. At least a portion of the charge connector 112 may be securably inserted into the aperture 126 so that the head portion 208 of the charge connector 112 may operably engage the electrical cable 208, or an attached electrical connector 210, with the charge tunnel unit 104. The electrical cable 208 may transmit a charge from a printhead component 101, such as a drop generator 14, to the charge tunnel unit 104 for transfer to an ink droplet(s) passing through the slot 138.

The charge tunnel unit 104 may be secured to the charge unit base 106 through the use of a fastener. For example, in the illustrated embodiment, at least a portion of a locking fastener 110 may be passed through a generally arc-shaped slit 124 in the distal end 134 of the charge tunnel unit 104, and into the mating hole 178 in the charge tunnel base 106, shown in FIGS. 5 and 8. As previously mentioned, the hole 178 may have internal threads that mate the threads of the locking fastener 110. By tightening the locking fastener 110 in the hole 178, at least a portion of the distal end 134 of the charge tunnel unit 104 may be forcibly pressed against the charge tunnel base 106, thereby preventing the movement of the charge tunnel unit 104 relative to the charge tunnel base 106.

According to the illustrated embodiment, when the connection between the locking fastener 110 and the hole 178 in the charge tunnel base 106 is loose so that the charge tunnel unit 104 is not, or is to a lesser degree, forcibly pressed against the charge tunnel base 106, the charge tunnel unit 104 may be pivoted about the charge tunnel base 106. For example, an adjusting screw 168 that is retainably secured by the aperture 166 in the first protrusion 162 may operably engage the second sidewall 130 of the charge tunnel unit 104. Further, a spring 172 extending out from the chamber 170 in the second protrusion 164 may operably engage the first sidewall 128 of the charge tunnel unit 140. The spring 172 may constantly exert a force against the proximal end 136 of the charge tunnel unit 104, and vice versa. The spring may exert adequate force against the charge tunnel unit to allow for the desired rotational adjustment of the charge tunnel unit 104. Accordingly, as the adjusting screw 168 is loosened, the spring 172 elongates, and the proximal end 136 may pivotably move toward the first protrusion 162 as the extension 140 rotates in within the cavity 160, as indicated by “A” in FIG. 8. Conversely, as the adjusting screw 168 is tightened, the spring 172 compresses, and the and the proximal end 136 may pivotably move toward the second protrusion 164 as the extension 140 correspondingly rotates within the cavity 160. In embodiments in which the extension 140 is centered beneath the slot 138, the pivot point may be around the center of the slot 138. Further, because the slit 124 may have a generally arc-shaped configuration, the charge tunnel unit 104 may be capable of at least some pivotal movement without interference from the locking fastener 110. The engagement of the adjusting screw 168 may allow for the parallel adjustment of the slot 138 of the charge tunnel unit 138 with other printhead components 101, including the drop generator 14 and/or the nozzle 18.

Once the charge tunnel unit 104, and associated slot 138, have been pivoted to the desired orientation, the position of the charge tunnel unit 104 relative to the charge tunnel base 106 may be secured by the tightening of the locking fastener 110 in the aperture 126, and against the charge tunnel unit 104.

Embodiments of the present invention also provide for linearly adjusting the position of the charge tunnel base 106, and an attached charge tunnel unit 104, relative to the charge tunnel cradle 108 and/or the printhead deck 102, as shown by arrows “B” in FIG. 8. For example, the charge tunnel base 106 may rest upon the lower arm 194 of the charge tunnel base 108 between at least a portion of the first and second tabs 204, 206. The charge tunnel base 106 and charge tunnel cradle 108 may be connected by an adjustment fastener 184 that passes through the through-hole 184 in the charge tunnel cradle 108, and which is securably retained by the aperture 182 in the charge tunnel base 106. A spring 185 extending out of the recess 186 in the charge tunnel base 106 may exert a force against the charge tunnel cradle 108, and vice versa. Accordingly, as the adjustment fastener 184 is tightened, the spring 185 is compressed, and the charge tunnel base 106 moves in a linear direction closer to the upper arm 192 of the charge tunnel cradle 108. Conversely, when the adjustment fastener 184 is loosened, the spring 185 is extended, thereby pushing the charge tunnel base 106 away from the upper arm 192 of the charge tunnel cradle 108. Such adjustments may allow for modifications in the linear position of the slot 138 of a charge tunnel unit 104 that is attached to a charge tunnel base 106.

Further, as previously discussed, the charge tunnel cradle may include, or be operably connected to, a guide 202 that may assist in directing the linear movement of the charge tunnel base 106. Further, the first and second tabs 204, 206 in the charge tunnel cradle 108 may also assist in guiding the linear movement of the charge tunnel base 106.

A fastener 114 may pass through a through-hole 200 in the second tab 204 of the charge tunnel cradle 108, and may be retainably secured by an orifice 190 in the charge tunnel base 106. The opening of the through-hole 200 may have a generally linearly elongated configuration so that, when the fastener 114 is loosened, the linear position of the charge tunnel base 106 may be at least partially adjusted without interference from the fastener 114. However, when tightened, the fastener 114 may prevent the linear movement of the charge tunnel base 106 relative to the cradle 108, thereby locking the charge tunnel base 106 at the desired linear position.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A charge tunnel alignment system comprising:
a charge tunnel unit having a main body and an extension, the main body having a distal end and a slot, the distal end including a slit, the slot configured to transmit an electrical charge to a ink droplet passing through the slot;
a charge tunnel base having a first protrusion and a cavity, the cavity configured to receive the rotatable insertion of the extension;
an adjustment screw operably connected to the first protrusion, the adjustment screw operatively engaging the charge tunnel unit to pivotably adjust the orientation of the charge tunnel unit; and
a locking fastener, the locking fastener configured to be securably retained in a hole in the charge tunnel base, the locking fastener passing through the slit and into the hole to operably secure the charge tunnel unit to the charge tunnel base.

2. The charge tunnel alignment system of claim 1, wherein the charge tunnel base includes a second protrusion having a chamber, the chamber configured to receive the insertion of at least a portion of a spring, the spring extending from the chamber and operably engaging the charge tunnel unit to exert a force against the charge tunnel unit.

3. The charge tunnel alignment system of claim 2, further including a charge tunnel cradle, the charge tunnel cradle including at least one through-hole, wherein a fastener passes through the through-hole and is operably retained by the charge tunnel base, thereby operably securing the charge tunnel base to the charge tunnel cradle.

4. The charge tunnel alignment system of claim 3, wherein the charge tunnel base includes an aperture and a recess, the aperture configured to retainably receive an adjustment fastener, at least a portion of the adjustment fastener passing through a through hole in the charge tunnel cradle to operably connect the charge tunnel base to the charge tunnel cradle, the recess configured to receive the insertion of at least a portion of a spring, the spring extending from the recess and operably engaging the charge tunnel cradle, and wherein the adjustment fastener is configured to move the charge tunnel base in a linear direction.

5. The charge tunnel alignment system of claim 4, wherein the charge tunnel base includes a groove that engages a guide in the charge tunnel cradle, the groove and guide assisting in guiding the linear movement of the charge tunnel base.

6. The charge tunnel alignment system of claim 5, wherein the guide has an annular configuration.

7. The charge tunnel alignment system of claim 5, wherein the charge unit cradle includes a first tab and a second tab, the first tab and the second tab configured to assist in guiding the linear movement of the charge tunnel base.

8. The charge tunnel alignment system of claim 1, wherein the charge tunnel base includes a first end and a second end, the second end including an aperture, the aperture configured for a retainable engagement with a charge connector.

9. The charge tunnel alignment system of claim 1, wherein the extension has a generally cylindrical configuration, and wherein the extension is centered approximately beneath the slot.

10. A charge tunnel alignment system comprising:
a charge tunnel unit having a main body and an extension, the main body having a proximal end and a distal end, the distal end including a slit, the extension having a generally cylindrical configuration, the slot configured to transmit an electrical charge to a ink droplet passing through the slot;
a charge tunnel base having a first protrusion and a cavity, the cavity configured to receive the rotatable insertion of the extension;
an adjustment screw operably connected to the first protrusion, the adjustment screw operatively engaging the charge tunnel unit to pivotably adjust the orientation of the charge tunnel unit;
a locking fastener, the locking fastener configured to be securably retained in a hole in the charge tunnel base, the locking fastener passing through the slit and into the hole to operably secure the charge tunnel unit to the charge tunnel base; and
a charge tunnel cradle, the charge tunnel cradle including at least one through-hole, wherein at least a portion of a fastener passes through the through-hole and is operably retained by the charge tunnel base, the fastener operably securing the charge tunnel base to the charge tunnel cradle.

11. The charge tunnel alignment system of claim 10, wherein the charge tunnel base includes an aperture and a recess, the aperture configured to retainably receive an adjustment fastener, at least a portion of the adjustment fastener passing through a through hole in the charge tunnel cradle to operably connect the charge tunnel base to the charge tunnel cradle, the recess configured to receive the insertion of at least a portion of a spring, the spring extending from the recess and operably engaging the charge tunnel cradle, and wherein the adjustment fastener is configured to move the charge tunnel base in a linear direction.

12. The charge tunnel alignment system of claim 1 1, wherein the charge tunnel base includes a groove that engages a guide in the charge tunnel cradle, the groove and guide assisting in guiding the linear movement of the charge tunnel base.

13. The charge tunnel alignment system of claim 12, wherein the guide has an annular configuration.

14. The charge tunnel alignment system of claim 13, wherein the charge unit cradle includes a first tab and a second tab, the first tab and the second tab configured to assist in guiding the linear movement of the charge tunnel base.

15. The charge tunnel alignment system of claim 10, wherein the charge tunnel base includes a first end and a second end, the second end including an aperture, the aperture configured for a retainable engagement with a charge connector.

16. The charge tunnel alignment system of claim 10, wherein the extension is centered approximately beneath the slot.

17. A method of aligning a charge tunnel system of a continuous inkjet printer with a drop generator and a catcher, the method comprising:
engaging an adjustment screw to pivotably adjust the orientation of a charge tunnel unit, the adjustment screw being operably retained by a charge tunnel base, the charge tunnel base being operably connected to the charge tunnel unit;
engaging a locking connector to secure the pivotable position of the charge tunnel unit relative to the charge tunnel base;
engaging an adjustment fastener to adjust the linear position of the charge tunnel base, the adjustment fastener being operably connected to the charge tunnel unit; and
engaging a fastener to secure the linear position of the charge tunnel base.

18. The method of claim 17, wherein said engaging a fastener comprises engaging a fastener the passes through a through hole in a charge tunnel cradle, the fastener being retainably secured in an aperture in the charge tunnel base.

19. The method of claim 17, wherein said engaging an adjustment screw comprises tightening or loosening an adjustment screw that is operably connected to the charge tunnel base, thereby adjusting the elongation of a spring that exerts a force on the charge tunnel unit.

20. The method of claim 19, wherein said engaging an adjustment fastener comprises tightening or loosening an adjustment fastener that is operably connected to the charge tunnel base, thereby adjusting the elongation of a spring that exerts a force on the charge tunnel base.
